(19) United States
(12) Patent Application Publication
(10) Pub. No.: US 2004/0237386 A1
(43) Pub. Date: Dec. 2, 2004

(54) Production method and system for ornamental plants

(76) Inventors: Kristian Madsen, Odense N (DK); Rune Nielsen, Odense N (DK)

Correspondence Address: STITES & HARBISON PLLC, 1199 NORTH FAIRFAX STREET, SUITE 900, ALEXANDRIA, VA, 22314, US

(21) Appl. No.: 10/488,865

(22) PCT Filed: Sep. 6, 2002
(86) PCT No.: PCT/DK02/00579

(30) Foreign Application Priority Data
Sep. 7, 2001 (DK) PA200101310

(51) Int. Cl. A01C 1/00

(52) U.S. Cl. 47/1.01 P; 47/58.1 SE

(57) ABSTRACT

The present invention relates to a production method and corresponding system for ornamental plants, by which it is possible to apply the method of drought stress advantageously to reduce cell elongation of plants grown in a slowly absorbing material such as peat moss without the use of chemical retarding agents and simultaneously to increase the growth of the plants (i.e. the increase of dry substance) through a controlled application of carbondioxide at the vicinity of the plants.

### TECHNICAL FIELD

The present invention relates to production methods and associated systems for ornamental plants.

### BACKGROUND OF THE INVENTION

In a traditional production system used in greenhouses, the plants are grown on tables which are able to contain a certain amount of water. Water is applied to the table via a valve mounted on the table or via a suitable movable supply system mounted above the table. Typically, water is applied to the table to a height of approximately 15 mm above the surface of the table, and the water remains in the tables for approximately 20 to 40 minutes. The table often comprises a number of sections that can be supplied with water simultaneously. Systems of this kind requires comprehensive systems of pipelines as well as powerful pumps for the supply of water from reservoirs to these sections and for the return of water from the sections to the reservoirs. Typically up to 90% of the water is returned to the reservoir. Furthermore, large fertiliser mixers and associated pumps are required with corresponding return reservoirs. If a movable supply system is applied for the watering of the different sections, these systems furthermore require electrical power supply as well as an appropriate control system.

A system of the above kind and suffering from the above drawbacks is e.g. described in NL 8502868, which discloses a system comprising a grating serving as a support surface for pots containing plants, which grating is placed a certain distance above the bottom surface of a watertight tray, which during watering of the plants can be filled with a sufficient amount of water.

The application of the above kind of watering system comprising watertight sections gives rise to various problems. The sections being watertight means they are also air impermeable with the consequence that it is difficult to ascertain sufficient exchange of air at the middle of the table. Thus, it is often the plants grown along the edges of the different sections that become most “compact”, as these are more sufficiently supplied with air than plants located towards the middle portions of the sections. If the stand of the plants becomes too crowded, the plants are furthermore often attacked by grey mould (Botrytis) which afterwards has to be treated with chemical fungicides.

In a traditional production system used in greenhouses, it is furthermore known to apply carbon dioxide CO₂ to increase the growth of plants (i.e. to increase the production of dry substance). There are major differences in the growths of plants at concentrations of CO₂ around 300 ppm, which is the concentration found in normal atmospheric air, and at concentrations of around 1000 ppm, which can be applied in greenhouses. Providing the proper concentration of CO₂ in the greenhouse—and hence in the vicinity of the plants—is a very costly process and generally the dosage of CO₂ has to be high in order to raise the concentration of CO₂ throughout the volume of the greenhouse to the desired level. It would thus be advantageous to be able to concentrate the raised concentration of CO₂ to the space immediately surrounding the plants, where the higher concentration is in fact needed.

Furthermore the application of cultivation tables with a solid bottom surface leads to uneconomic heat consumption In the greenhouse. The heat generated by heater means placed at the bottom of the greenhouse, under the cultivation tables, will create a heavy flow of hot air in an upward direction in the gaps between the cultivation tables, and the plants that are located towards the middle portion of the tables will thus receive less heat from beneath than those located along the edges of the table. Consequently, it is often necessary to obtain more heat from the heater means located at the top of the greenhouse leading to a comparatively high temperature in the upper portion of the greenhouse and hence to a disadvantageous situation from an energy consumption point of view.

It is finally known within the art to apply the method referred to as drought stress to control the cell elongation of plants without using chemical retarding agents, which agents are undesirable from an environmental point of view. Such retarding agents are widely used in connection with flowering pot plants. The vast majority of pot plants grown and sold in Europe are grown partly or totally in peat moss. Peat moss has, however, some serious disadvantages in situations where the method of drought stress is applied. Thus, the ability of peat moss to absorb water is heavily reduced when the peat moss is dry, which means that the peat moss will not be able to rapidly absorb a sufficient amount of water when it is initially in a dry state. In practice this means that it will become difficult to approach the drought limit, because the driest plants—when grown in peat moss or the like—will not receive water supply at all. This leads to less uniform plants and generally to an increased waste of plants in a production.

### DISCLOSURE OF THE INVENTION

It is the object of the present invention to provide a method and a system for the automatic production of ornamental plants which method and system do not suffer from the above-mentioned disadvantages of traditional watering and air and CO₂ supply systems.

It is furthermore the object of the present invention to provide a method and a system, which allows the application of drought stress to control the cell elongation of plants without the application of chemical retarding agents, which method and system do not give rise to the problems connected with the application of drought stress described above.

These and other objects are attained with a method according to claim 1 and with a system according to claim 5.

According to the present invention there is thus provided a method for automatic production of ornamental plants comprising the following steps:

(a) providing at least one cultivation table comprising an air and liquid permeable support surface;

(b) placement of a plurality of ornamental plants—or pots/containers containing such plants—on said support surface;

(c) provision of water possibly mixed with a suitable fertiliser to said plants through said support surface;

(d) passing of a mixture of air and CO₂ through said support surface and along said plants;

(e) repeating said steps (c) and (d) a number of times N, where N may also be equal to 1;

(f) removing said plants from said at least one cultivation table.

A few comments on the above series of steps are pertinent:

In practice, the plants will normally remain on the cultivation table until they are to be sold, and only then be removed from the table as described in step (f) above.

Furthermore, there will in practice on principle be two possible terminations of the above series of method steps: Either the last activity of step (e) above could be the provision of water and fertiliser (i.e. step (c)) or it could be the passage of air and CO₂ through the support surface (i.e. step (d)).

In the following, water possibly mixed with a suitable fertiliser will generally be referred to as a cultivation liquid.

By placement of the plants on said air and liquid permeable support surface it is ascertained that the various plants can be supplied with equal amounts of air, CO₂ and cultivation liquid no matter where the plant is placed on the cultivation table. Thus, for instance the above-mentioned problems with grey mould attacks can be avoided. The flow of air can be increased if desired by the application of a suitable ventilation system in communication with the support surface of the cultivation table. Furthermore, it is possible by this controlled flow of air and CO₂ along each plant to control for instance the temperature and humidity directly at the plants, which may lead to a reduced energy consumption in the greenhouse.

The provision of cultivation liquid to the plants in step (c) above can according to the invention be controlled based on a number of parameters including combinations of these parameters. According to one embodiment of the invention, the determination of whether cultivation liquid should be applied to a particular cultivation table is based on the gross weight of the table, i.e. the weight of the table itself including support surface, the weight of pots or containers for the plants, the dry weight of the cultivation material in such pots or containers plus the weight of the plants themselves with a specific content of cultivation liquid, which will depend among other things on the stage of development of the plant. Based on a prior knowledge of these values it is possible to determine for instance upper and lower limits for the gross weight of the cultivation table and thereby to determine whether cultivation liquid supply to the particular table is required.

According to the invention, a very accurate dosage of the cultivation liquid supply to each individual plant can be obtained by providing said pots or containers with a rapidly absorbing reservoir which can rapidly absorb a sufficient amount of cultivation liquid via the support surface during step (c) above and thereafter gradually pass the cultivation liquid on to the plant(s) in the pot or container, without the cultivating table having to remain in connection with the watering system of the greenhouse. A possible way of implementing said rapidly absorbing reservoir would be to provide a pot or container comprising one or more access openings for cultivation liquid at the bottom surface hereof with a layer of rapidly absorbing material immediately above these access openings, above which rapidly absorbing layer, a layer of suitable cultivation substance containing the roots of the plant is provided. The cultivation substance will absorb water and fertiliser from the reservoir layer at a slower rate. In practice, a number of materials can be suitable for each of these layers. One of the characteristics determining the rate of absorption of the material will be the dimension of the pores of the material. A specific embodiment of a layered reservoir system of the above kind will be discussed in the detailed description of the invention.

According to the invention, there is furthermore provided a system for the automatic production of ornamental plants comprising:

(a) Means for supporting one or more plants—or pots/containers containing such plants—comprising an air and liquid permeable support surface in such a manner that a mixture of atmospheric air and CO₂ can flow through said support surface and along said plants and that said plant(s) can also be provided with cultivation liquid through said support surface;

(b) Means for the supply of cultivation liquid through said air and liquid permeable support surface;

(c) Means for the supply of said mixture of atmospheric air and CO₂ through said air and liquid permeable support surface;

(d) Means for determining whether said supply of cultivation liquid should take place;

(e) Means for moving said supporting means between said cultivation liquid supply means (b), said air and CO₂ supply means (c) and said determining means (d).

According to one embodiment of the invention, said means for supporting the plants—or the pots or containers containing these plants—comprises a square or rectangular frame and a flat bottom surface made of a grid or net of suitable mesh size to support the plants/pots or containers and simultaneously allow the necessary passage of air, CO₂ and cultivation liquid. Alternatively, a solid perforated plate, the perforation being in the form of through slits or holes, may form the support surface. A person skilled in the art may also conceive other equivalent embodiments. Finally as mentioned above and in more detail in the detailed description of the invention the pots or containers may contain a subdivided structure of material, whereby at least one reservoir portion for cultivation liquid and a cultivation portion accommodating at least the major part of the root of the plant are provided.

According to one embodiment of the present invention, said means for supply of cultivation liquid comprises a basin of such a shape that said square or rectangular frame with said flat bottom surface could be lowered into the basin for an appropriate interval of time. Alternatively, it would also be possible to raise the basin and thereby bring the liquid in the basin into contact with the support surface. The basin may not necessarily be upwardly open but may communicate with the support surface via a wet mat of suitable liquid absorbing material such as mineral wool, etc. Other alternatives will be obvious to a person skilled in the art depending on the actual implementation of the system.

According to one embodiment of the present invention, said means for supply of a mixture of air and CO₂ comprises a container, one surface of which may be brought into fluid communication with said support surface and the container being provided with inlet means for air and CO₂.

It is well known that the rate of growth as well as the final quality of plants can be increased very much, especially during the darker periods of the year, by the application of light to the plants. In prior art systems, light emitting means are normally placed above the table supporting the plants and as the plants grow, the lower portions of the plants consequently receive less light and eventually practically no light at all. This is a serious disadvantage of prior art systems, as the lack of sufficient light to the lower portions of the plants will increase the risk of fungal diseases in these portions and also the development of mildew and yellow leaves.

According to another embodiment of the present invention, the above problem of insufficient amount of light to the lower portions of the plants is solved by placing light emitting means beneath the support surface, whereby the plants can be supplied with both an air/CO₂ mixture and a controlled amount of light from beneath via the openings in the support surface. The amount of light delivered from these means can for instance be controlled by a computer also receiving signals from appropriately placed light sensors beneath the plants and at other locations in the greenhouse.

According to the present invention, said means for determining whether said supply of cultivation liquid may as described above be based on a determination of the gross weight of the cultivation table, which gross weight includes the time varying weight of the plants. According to one embodiment of the invention, said determining means thus comprises a weighing station provided with for instance one or more weighing cell(s), the output signal from this (these) cell(s) being provided to a control system, controlling the various functions of the production system.

It is however also possible to include other parameters as determining factors, not only for the necessary supply of cultivation liquid to the plants but also for the supply of air and for the concentration of CO₂ at the corresponding supply station. It would for instance be possible to provide each separate cultivation table with an individual barcode or a transponder that could be read by the control system. The application of such or similar means, and hence the provision of an individual table-code, on each individual cultivation table would result in several possibilities: Apart from the weight of each plant, the control system may for instance receive information about which kinds of plants are present on the particular table (i.e. the system may contain a number of cultivation tables not necessarily containing the same kind of plants), the age of these plants and the lower weight limit for these plants under which the plants should not be supplied with cultivation liquid. The control system may furthermore compute the weight of the leaves based on the age of the plants and subtract this from the total weight of the cultivation liquid. It will furthermore be possible to exchange the cultivation liquid in the basin in case the plants on a particular table require a different fertiliser or concentration hereof. Other pertinent parameters characterising each individual table may of course be provided to the control system in the above manner and lead to corresponding measures, which will be evident to somebody skilled in the art.

Said means for moving said supporting means between said cultivation liquid supply means, said air and CO₂ supply means and said determining means may be implemented in several different ways. According to one embodiment of the present invention said means for moving comprises an endless conveyor system for circulating the cultivation tables a suitable number of times over said cultivation liquid supply means, air and CO₂ supply means and determining means. If the cultivation tables pass the same location on the conveyor system for instance several times a day, a single means for crop- or pesticide spray may be located at a convenient place and thereby reduce the necessary installations required to spray all plants appropriately. Such spray means could of course also be controlled by the control system also based for instance on information derived from said barcode or transponder. The supply of cultivation liquid and/or air and CO₂ may not necessarily take place at only one corresponding station along the conveyor system but can if desired take place at several such stations. Finally, said means for moving said supporting means between said cultivation liquid supply means, said air and CO₂ supply means and said determining means may be implemented without the use of an (endless) conveyor system as described above, but could for instance be implemented using a suitably controlled industrial robot.

The method and system described above offers a number of advantages over traditional production systems. The dosage of CO₂ directly through the support surface of the cultivation table provides for the possibility to apply CO₂ to the plants simultaneously with the ventilation of the greenhouse. The application of air and CO₂ through the support surface generally ensures a good and uniform supply of air and CO₂ to all plants on the table. Furthermore, due to the fact that CO₂ is applied directly in those regions where it is needed, the overall dosage of CO₂ in the greenhouse can be reduced. Moreover, the problem mentioned initially in the background of the invention of an uneconomically high heat consumption in the greenhouse is reduced by the method and system according to the present invention.

Furthermore, it has been found that the increased flow of air past each individual plant on the support surface made possible by the system according to the invention leads to a reduction of overall production time of the plants.

### BRIEF DESCRIPTION OF THE DRAWINGS

The invention will now be described in more detail with reference to the accompanying drawings, in which

FIG. 1 is a schematic representation of a production system according to the present invention viewed from above;

FIG. 2 is a side elevational view of a detail of the system shown in FIG. 1;

FIG. 3 is a vertical cross sectional view of a pot for use in one embodiment of the present invention; and

FIG. 4 is a graph over gross weight of container and plant as a function of time for normal production method and production method according to the present invention.

### DETAILED DESCRIPTION OF THE INVENTION

In the following, a detailed description of one embodiment of the invention is given.

According to the invention, the production method for ornamental plants comprises the following main steps:

(a) providing at least one cultivation table 2 provided with an air and liquid permeable support surface 4;

(b) placement of a plurality of ornamental plants 17 contained in pots 3 on said support surface 4;

(c) provision of cultivation liquid to said plants 17 through said support surface 4 and through suitable access ports in said ports 3;

(d) passing of a mixture of air and CO₂ through said support surface 4 and along said plants 17;

(e) repeating said steps (c) and (d) a sufficient number of times;

(f) removing said plant 17 from said cultivation table 2.

According to this embodiment of the invention, the provision of cultivation liquid is controlled by determining the gross weight of the cultivation table 2 including the plants. The weight of the table itself, the total weight of the pots on the table and the dry weight of the material in the pots are all known a priory and as it is also possible to calculate the weight of the leaf of the plants at different stages of development, it becomes possible to calculate the liquid content of the plants. Either the total weight of the plant or alternatively the calculated content of liquid in the plant can be used to determine the necessary supply of cultivation liquid. Optimally each cultivation table 2 should pass the cultivation liquid supply means 5 to 10 times during a 24 hours period.

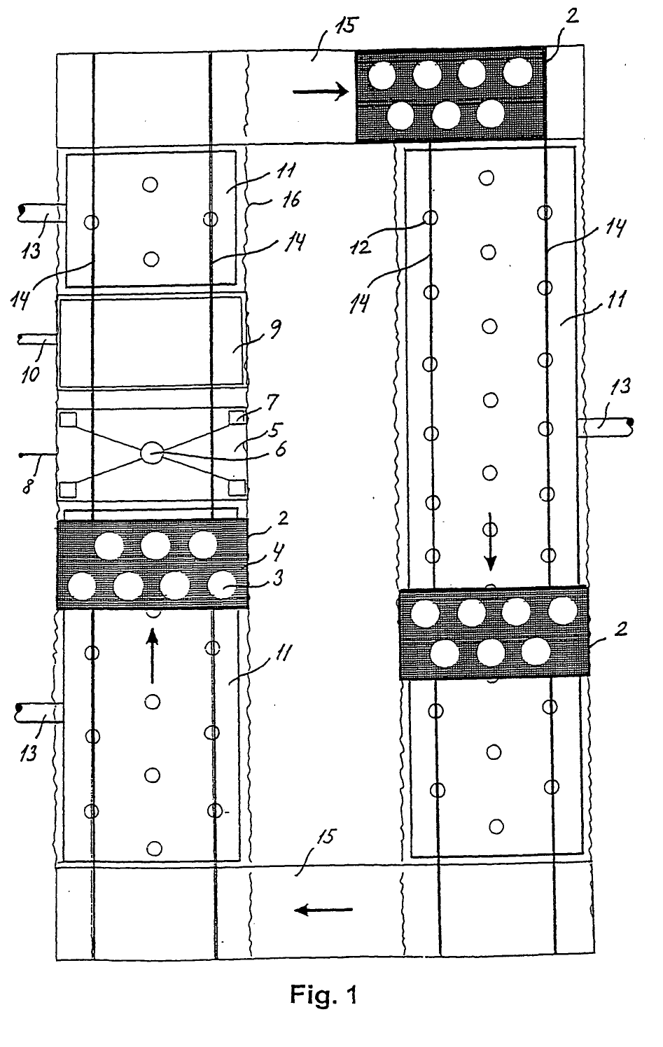

Referring now to FIG. 1, there is shown an embodiment of the production system for ornamental plants, the system being generally designated by 1.

The system basically comprises an “endless” transport system comprising two rows of rails 14 extending in parallel and two transversal conveyor means 15. The rails 14 and conveyor means 15 carry a number of cultivation tables 2, of which three are shown in FIG. 1, although the number in practice normally will be much larger, the cultivation tables 4 occupying the majority of the available space of the transport system 14, 15. The cultivation tables 2 comprise an air and liquid permeable support surface 4, which according to this embodiment of the invention is formed by a grid of sufficiently fine meshes to support the pots 3 located hereon.

Placed on the support surface 4, there is a number of pots 3 containing the plants 17 and a suitable cultivation material to be described in detail in the following. The pots 3 are provided with openings in the bottom through which openings liquid can flow into the material in the pots.

Placed beneath the transport system 14, 15 is a weighing station 5 comprising a weighing cell 6 connected to a number of support means to be brought into contact with the cultivation table 2. The output 8 from the weighing cell 6 is connected to the control system (not shown) which controls the operation of the production system 1. Adjacent the weighing station 5 and under the transport system 14, 15 there is located the cultivation liquid station 9 comprising a basin, the inner shape and dimensions of which allow for the cultivation table 2 to be lowered into the basin to a sufficient depth. Cultivation liquid can be supplied to and extracted from the watering station through the pipeline 10.

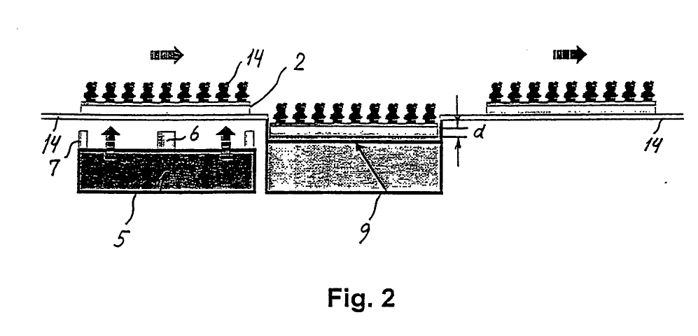

Referring to FIG. 2, there is shown the arrangement of the weighing station 5 and the cultivation liquid supply station 9 according to this embodiment of the invention. Once a specific cultivation table 2 has reached a position directly above the weighing station 5, it is halted at that position and the weighing station is raised into contact with the cultivation table 2 as indicated by the arrows. After determining the weight of the cultivation table 2, the weighing station 5 is again lowered to its initial position and the cultivation table 2 proceeds to a new position directly above the cultivation liquid supply station 9. At this position, the cultivation table 2 is lowered until an appropriate contact with the liquid in the cultivation liquid supply station 9 is established, i.e. until a position, where the cultivation table is submerged to an appropriate depth as indicated by the distance d in FIG. 2. If the pots 3 containing a rapidly absorbing reservoir as described in the following are being used, the cultivation table 2 need only to remain at this position for a very short interval of time, in practice down to a few seconds. Hereafter the cultivation table 2 is again raised to its original level as before the cultivation liquid supply station 9 and it proceeds down the conveyor system 14, 15.

Placed beneath the transport system 14, 15 carrying the cultivation tables 2 there is a supply system 11 for either a mixture of atmospheric air and CO₂ or for CO₂ alone.

Referring to FIG. 1, the supply system 11 for CO₂ (and possibly for atmospheric air) is implemented as a system of containers of a rectangular cross section extending underneath the transport system comprising the transport rails 14 except for those portions of the transport system comprising the weighing station 5 and the watering station 9. The upper surface of these containers are provided with an appropriately distributed pattern of outlet orifices 12 from where the CO₂ and possibly air can flow upward towards the support surface 4 of the cultivation tables 2. Each of said containers are provided with either a single inlet 13 for CO₂ or for a mixture of CO₂ and air, but it is understood that CO₂ and air could also be supplied to the containers via separate inlets, the mixing thus taking place in the containers.

In practice, the supply system for CO₂ and possibly air could, however, also be implemented using a hose provided with a number of outlets along the length of the hose. For the supply of CO₂ it would for instance be possible to apply a hose or a number of hoses distributed under the transport system 14, the diameter of the hose(s) being approximately 20 mm with outlets placed at intervals of 2 to 4 metres. From the hose CO₂ will slowly diffuse through the support surface 4 of the cultivation tables 2. If a supply of atmospheric air is desired, this supply could take place via one or more hose(s) of a somewhat larger diameter (for instance a diameter of 25 to 40 cm with orifices placed at an interval of 0.5 to 2 metres). The forced supply of atmospheric air will lower the concentration of CO₂, but this can be advantageous during periods of the year where the air in the greenhouse has a high humidity, and where it will be advantageous to increase the velocity of air along the plants in order to increase evaporation.

In order to ascertain that the flow of CO₂ and possibly air actually take place from the supply system 11 via the support surface 4 and up along the plants 17 placed on this surface and not for instance around the edges of the cultivation tables 2, a curtain 16 may be hung from the level of the upper edges of the cultivation tables 2 to the floor of the building. In this manner, the flow of air and CO₂ is forced through the mass of plants 17 before it reaches the upper regions of the greenhouse.

A controlled flow of air and CO₂ from the supply system 11 directly to the plants 17 will have the further beneficial effect of reducing the energy consumption associated with heating of the air in the greenhouse, as the temperature of the air and CO₂ is controlled at the precise location, where it is required.

As mentioned previously in the disclosure of the invention, it is particularly advantageous to provide the pots 3 with a reservoir for quickly absorbing and containing a certain amount of cultivation liquid, from which reservoir the liquid can be gradually passed on a the cultivation material in the pot containing at least a major part of the root of the plant. The combination of the above described production system and this particular kind of material in the pots is highly advantageous in that it provides for a very accurate dosage of the supply of cultivation liquid to the plants and the application of the method generally referred to within the art as drought stress in order to control the growth of plants without environmentally undesirable application of chemical retarding agents. The application of a reservoir and adjacent cultivation portion within the pots will in the following be referred to as “Capilar Controlled Watering” (CCW) and is also the subject of co-pendent patent application entitled “Capilar controlled watering” with the same applicant as the present application. (Application number will be inserted when available).

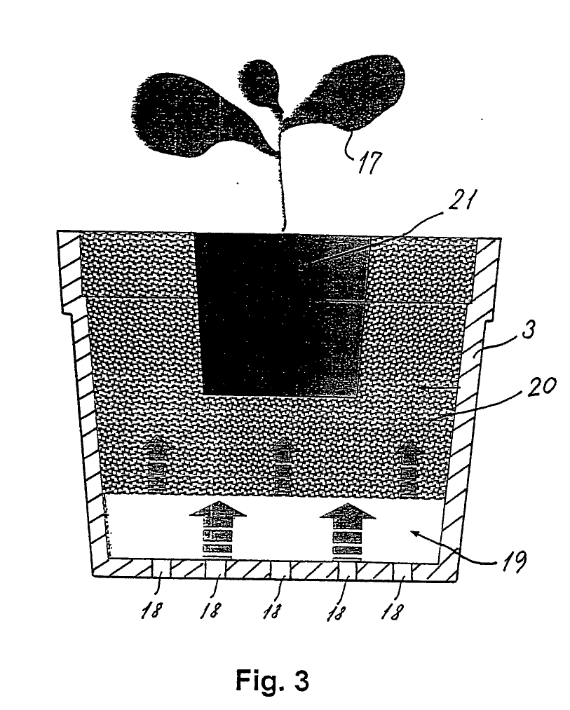

A preferred embodiment of a pot 3 for application in the system according to the present invention is shown in FIG. 3. The pot 3 comprises a number of access openings 18 distributed over the bottom face of the pot. Directly above these access openings 18 there is located said rapidly absorbing reservoir which according to this embodiment consists of a layer 19 of a porous material with relatively large pores and hence the ability to rapidly absorb a liquid and also to contain a relatively large amount of such liquid. Above and in contact with the layer 19 there is provided a second porous layer 20 of a suitable cultivation substance such as peat moss with relatively smaller pores than layer 19. When the reservoir layer 19 has been filled with liquid, the liquid Is gradually sucked up into the cultivation layer 20, from where it is absorbed by the roots of the plant either directly or via a Jiffy pot 21 inserted in the cultivation layer 20. One advantage of the application of a pot of the kind described above is that when drought stress is applied in the production process, there will be no problems of providing the plants with cultivation liquid, even though the cultivation substance 20 initially is in a very dry state. Furthermore, as the size of the pores in layer 19 is large and in layer 20 much smaller the additional advantages, side effect is obtained that the reservoir layer 19 will dry up faster than the cultivation layer 20, because the larger capillary rise pressure of the smaller pores of layer 20 empties this layer of liquid, thus leaving a dry zone at the bottom of the pot. The roots of the plant will therefore only penetrate a short distance into the dry reservoir layer and not fill up the bottom portion of the pot. Thus, in case of too large supply of liquid at the end user, the roots will not suffer from suffocation due to lack of air supply to the same degrees as traditionally cultivated plants.

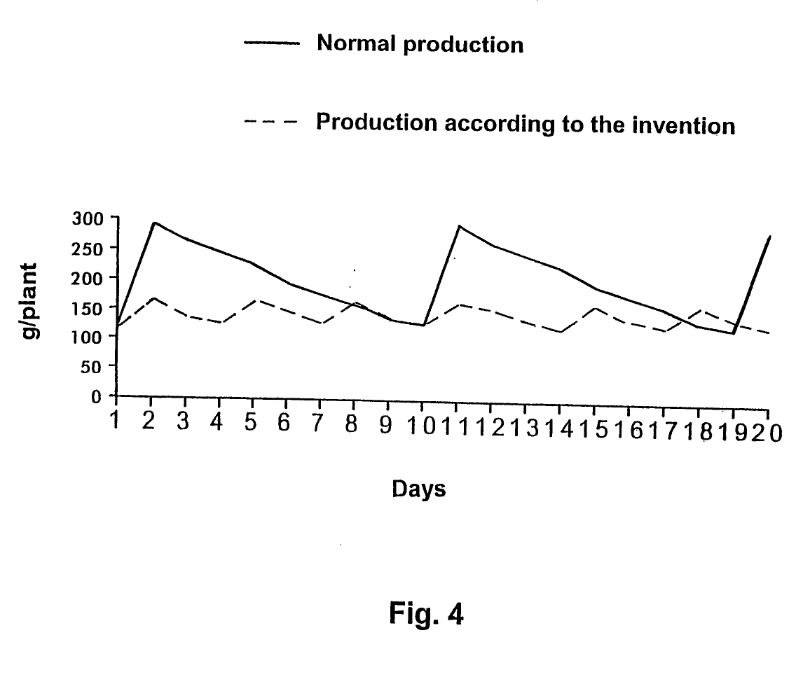

Referring now to FIG. 4, there is finally shown results of a practical experiment with two different liquid supply systems, a traditional system applying drought stress to control the growth of plants but without the application of the pots 3 described above in connection with FIG. 3 and a system applying the CCW method according to the invention. More specifically, the graph in FIG. 4 shows the gross weight of a pot (i.e. material in the pot and plant) as a function of time for the traditional production system and for a production system applying the CCW technique. It is evident from the graph that in case of traditionally drought stress grown plants there will be large intervals of time (several days) after the supply of liquid has taken place, where no drought stress effect will occur at all. In fact, only some 10 to 20 percent of the production time, a drought stress effect will be obtained. On the other hand, in case of the CCW technique it will be possible to increase and decrease the degree of drought stress by changing the lower weight limit determining whether liquid should be supplied.

Although one particular embodiment of the present invention has been shown and described in the preceding parts of the detailed description, it is understood that a person skilled in the art may conceive other embodiments of the invention without departing from the scope of the invention as defined by the following claims.

### REFERENCE NUMERALS

1. Production system

2. Cultivation table

3. Container or pot

4. Support surface

5. Weighing station

6. Weighing cell

7. Support means in weighing station

8. Output from weighing cell

9. Cultivation liquid supply station

10. Supply pipeline

11. Supply system for air and CO₂

12. Orifice

13. Supply pipeline

14. Transport rail

15. Conveyor means

16. Skirt

17. Plant

18. Access openings in pot

19. Rapidly absorbing layer

20. Cultivation layer

21. Jiffy pot

1. Method for production of ornamental plants comprising the following steps:
(a) providing at least one cultivation table provided with an air and liquid permeable support surface;
(b) placement of a plurality of ornamental plants—or pots/containers containing such plants—on said support surface;
(c) at a first station determination of whether said plants require a supply of a cultivation liquid;
(d) if in step (c) it is found to be required to supply said cultivation liquid, provision hereof to said plants via said support surface at a second station;
(e) passing of a mixture of air and carbon dioxide CO₂ through said support surface and along said plants;
(f) repeating said steps (c), (d) and (e) a number of times;
(g) removing said plant from said cultivation table.

2. Method according to claim 1, characterized in that said provision of cultivation liquid takes place by a displacement of said cultivation table relative to said second station, whereby cultivation liquid penetrates said liquid permeable support surface.

3. Method according to claim 2, characterized in that said relative displacement comprises a lowering of the cultivation table into the second station.

4. Method according to claim 2, characterized in that said relative displacement comprises a raising of the second station, whereby it is brought into contact with the cultivation table via said liquid permeable support surface.

5. Method according to claim 1, where said provision of cultivation liquid to said plants takes place in the following steps:
(h) provision of said cultivation liquid to a rapidly absorbing reservoir; and
(i) provision of said cultivation liquid from said reservoir to a cultivation substrate in contact with the plants.

6. Method according to claim 1, where said cultivation liquid is a mixture of water and fertilizer.

7. Method according to claim 1, where said determination is based on the weight of the plants.

8. Method according to claim 1, where the plants are furthermore supplied with light emitted from suitable light-emitting means placed beneath said support surface.

9. System for production of ornamental plants comprising:
means for supporting one or more plants—or pots/containers containing such plants—comprising an air and liquid permeable support surface in such a manner that a mixture of atmospheric air and CO₂ can flow through said support surface and along said plants and such that said plants can also be provided with a cultivation liquid through said support surface;
means for the supply of said cultivation liquid through said air and liquid permeable support surface;
means for the supply of said mixture of atmospheric air and CO₂ through said air and liquid permeable support surface;
means for determining whether said supply of cultivation liquid to said plants should take place;
means for moving said supporting means between said cultivation liquid supply means, said air and CO₂ supply means and said determining means.

10. System according to claim 9, where said means for moving said cultivation table comprises a closed loop of conveyor means.

11. System according to claim 9, where said means for moving said cultivation table comprises a robot.

12. System according to claim 9, where said pots or containers comprise a reservoir for rapidly absorbing an amount of said cultivation liquid from said means for the supply of said cultivation liquid through said air and liquid permeable support surface.

13. System according to claim 12, where said pots or containers furthermore comprise a body of cultivation substrate in liquid communication with said reservoir, said cultivation substrate accommodating the roots of said plant.

14. System according to claim 13, where said cultivation substrate absorbs said cultivation liquid from said reservoir at a slower rate than the rate by which said reservoir absorbs said cultivation liquid from said supply means.

15. System according to claim 9, where the system furthermore comprises one or a plurality of light-emitting means placed beneath said support surfaces for providing the plants placed on these support surfaces with a controlled amount of light from beneath.

16. Method according to claim 1, characterized in that the provision of said cultivation liquid takes place at a plurality of said means for the supply of said cultivation liquid through said air and liquid permeable support surface.

17. System according to claim 9, characterized by the system being provided with means for displacement of said support surface relative to the cultivation liquid supply means, whereby cultivation liquid penetrates said liquid permeable support surface.

18. System according to claim 18, characterized in that said displacement is carried out by displacing the support surface in a downward direction into contact with the cultivation liquid supply means.

19. System according to claim 18, characterized in that said displacement is carried out by displacing the cultivation liquid supply means in an upward direction into contact with the support surface.

20. System according to claim 9, characterized by comprising a plurality of said means for the supply of said cultivation liquid through said air and liquid permeable support surface.
